(19) United States
(12) Patent Application Publication
(10) Pub. No.: US 2024/0425336 A1
(43) Pub. Date: Dec. 26, 2024

(54) HANDLING MACHINE INCLUDING A FUEL CELL AND A TANK FOR HOLDING HYDROGEN

(71) Applicant: MANITOU BF, ANCENIS (FR)

(72) Inventors: Pacôme FREREBEAU, ANCENIS (FR); Xavier SCHELL, ANCENIS (FR); Valentin BREHIER, ANCENIS (FR)

(21) Appl. No.: 18/704,803

(22) PCT Filed: Oct. 21, 2022
(86) PCT No.: PCT/EP2022/079470

§ 371 Date: Apr. 25, 2024

(30) Foreign Application Priority Data
Oct. 26, 2021 (FR) FR2111356

(51) Int. Cl. B66F 9/075

(52) U.S. Cl. CPC B66F 9/07572; B66F 9/07518; B66F 9/07531

(57) ABSTRACT

The invention relates to handling equipment (1) comprising:
a chassis (2) having a median longitudinal axis (X);
a load-handling device (3) which is mounted such as to be able to move on the chassis (2);
an electric motor (11, 12, 13) which is configured to move the handling equipment (1) or to actuate the load-handling device (3);
a fuel cell (17) which is configured to generate electrical energy intended to power the electric motor (11, 12, 13);
a tank (16, 32) intended to contain hydrogen and connected to the fuel cell (17) in order to supply same with hydrogen;
a driver's cab (22) which is fixed to the chassis (2) and is positioned on a first side of the chassis (2) with respect to the median longitudinal axis (X) of the chassis (2);
a casing (23) which is fixed to the chassis (2) and is positioned on a second side of the chassis (2) which is the opposite to the first side, with respect to the median longitudinal axis (X) of the chassis (2);
of the fuel cell (17) and the tank (16, 32) at least one being housed inside said casing (23).

### TECHNICAL FIELD

The invention relates to the field of handling equipment comprising a load-handling device, an electric motor configured to move the handling equipment or to actuate the load-handling device, a fuel cell generating electrical energy intended to power the electric motor, and a tank intended to store hydrogen and connected to the fuel cell in order to supply same with hydrogen.

### TECHNOLOGICAL BACKGROUND

Document U.S. Pat. No. 6,688,481 discloses a crane which comprises a chassis, a telescopic arm which is mounted in an articulated manner on the chassis and an electric motor which is configured to provide the propulsion of the crane. According to one embodiment, the crane comprises a fuel cell system connected to the electric motor in order to provide same with electrical power. The fuel cell system forms part of a counterweight positioned to the rear of the vehicle chassis.

Such handling equipment is not entirely satisfactory, notably insofar as the aforementioned layout of the fuel cell system does not afford it sufficient protection against knocks and neither is the driver sufficiently protected against leaks of hydrogen from the fuel cell system.

### SUMMARY

One idea behind the invention is to propose handling equipment of the aforementioned type, namely comprising a fuel cell and a hydrogen storage tank, which offers enhanced safety, notably in the event of a hydrogen leak.

A first subject matter of the invention proposes handling equipment comprising:
a chassis having a median longitudinal axis X;
a load-handling device which is mounted such as to be able to move on the chassis;
an electric motor which is configured to move the handling equipment or to actuate the load-handling device;
a fuel cell which is configured to generate electrical energy intended to power the electric motor;
a tank intended to contain hydrogen and connected to the fuel cell in order to supply same with hydrogen;
a driver's cab which is fixed to the chassis and is positioned on a first side of the chassis with respect to the median longitudinal axis X of the chassis;
a casing which is fixed to the chassis and is positioned on a second side of the chassis which is the opposite to the first side, with respect to the median longitudinal axis X of the chassis;
of the fuel cell and the tank at least one being housed inside said casing.

Thus, the element or elements housed inside the casing are protected against knocks. Furthermore, in the event of hydrogen leaking from this (these) element(s), the leak is localized to inside the casing, making it easier to detect and to remove. In addition, because the casing is positioned on the opposite side from the driver's cab, any leaks are situated some distance from the driver's cab, thereby increasing driver safety. Finally, the elements housed inside the casing contribute to the lateral balancing of the handling equipment by acting as a counterweight to the driver's cab.

According to some embodiments, such handling equipment may exhibit one or more of the following features.

According to one embodiment, the handling equipment comprises a front axle and a rear axle which are mounted on the chassis transversely with respect to the median longitudinal axis X and which each comprise two wheels.

According to one embodiment, the driver's cab is situated between the front axle and the rear axle.

According to one embodiment, the casing is situated between the front axle and the rear axle.

According to one embodiment, the chassis comprises a pair of longitudinal members extending longitudinally one respectively on each side of said median longitudinal axis X, the driver's cab and the casing being positioned one on each side of the pair of longitudinal members.

According to one embodiment, the handling equipment further comprises an electrical energy storage device, the fuel cell and the electrical energy storage device being electrically connected, on the one hand, to one another and, on the other hand, in parallel, to the electric motor.

According to one embodiment, the energy storage device comprises one or more batteries and/or one or more supercapacitors.

According to one embodiment, the energy storage device comprises one or more batteries for example of the lithium-ion type.

According to one embodiment, the energy storage device is housed in a space formed between the longitudinal members of the pair of longitudinal members. Thus, the energy storage device contributes to the lateral balancing of the handling equipment, or at least makes no significant contribution to any lateral imbalance of the handling equipment since the center of mass of the electrical energy storage device is situated relatively close to, or even exactly on, the median longitudinal axis of the handling equipment. Furthermore, this arrangement allows the energy storage device to be protected against knocks. In addition, this arrangement allows the electrical energy storage device to be isolated from any hydrogen leaks that may occur in the casing. This arrangement also allows the electrical energy storage device to be isolated from the heat generated by the fuel cell, thereby limiting the risks of said electrical energy storage device overheating.

According to one embodiment, the electrical energy storage device is situated to the rear of the front axle and, for example, between the front axle and the rear axle.

According to one embodiment, the handling equipment comprises a DC/DC voltage converter which is connected, on the one hand, to the fuel cell and, on the other hand, to the electric motor and to the electrical energy storage device.

According to one embodiment, the voltage converter is housed in the space formed between the longitudinal members of the pair of longitudinal members. This allows the voltage converter to be protected against knocks, and isolated from any hydrogen leaks that may occur inside the casing, and from the heat generated by the fuel cell.

According to another embodiment, the voltage converter is housed inside the casing.

According to one embodiment, the fuel cell and the tank are housed inside the casing.

According to one embodiment, the tank is arranged at the rear of the handling equipment, namely to the rear of the driver's cab and of the casing.

According to one embodiment, the handling equipment comprises several tanks. According to one variant of this embodiment, one of the tanks is situated at the rear of the handling equipment.

According to one embodiment, the tank is a pressurized hydrogen tank suitable for storing hydrogen at a maximum pressure of between 300 and 700 bar. According to another embodiment, the tank is a tank for storing hydrogen in the form of hydrides.

According to one embodiment, the tank and the fuel cell are connected by a circuit equipped with an expansion valve, said circuit being housed inside the casing.

According to one embodiment, the fuel cell is equipped with an air supply compressor and with a humidifier device.

According to one embodiment, the handling equipment comprises a cooling device enabling cooling of the fuel cell, said cooling device comprising, for example, a cooling circuit equipped with a heat exchanger, and being housed inside the casing.

According to one embodiment, a fan is housed inside the casing.

According to one embodiment, the handling equipment comprises a hydrogen detector which is housed inside the casing. This enables reliable detection of any hydrogen leaks that might occur.

According to one embodiment, the hydrogen detector is housed in an upper portion of the casing, which means to say above the tank and above the fuel cell. This further improves the reliability with which hydrogen is detected.

According to one embodiment, the casing comprises a mobile cover. Thus, equipment housed inside the casing is easily accessible, notably for maintenance operations.

According to one embodiment, the casing has a vent for removing a flow of gas from an internal space of the casing.

According to one embodiment, the vent is positioned closer, in a transverse direction, to the median longitudinal axis X than to a lateral end of the handling equipment on the second side and below an upper edge of the load-handling device in a lowered position, so as to avoid the vent being obstructed in the event of the handling equipment overturning.

According to one embodiment, the casing comprises an air inlet opening which is preferably formed at the front of the casing.

According to one embodiment, the vent is positioned in an upper rear portion of the casing.

According to one embodiment, the vent is positioned further toward the rear than the driver's cab in the longitudinal direction. This ensures that any hydrogen leaks that might occur are discharged away from the driver's cab.

According to one embodiment, the vent is positioned above that wheel of the rear axle which is positioned on the second side.

According to one embodiment, the vent is directed upward.

According to one embodiment, the vent is inclined in such a way that the direction of the gas flow, in projection in a transverse plane, is inclined toward the outside by an angle comprised between 5 and 45° with respect to a vertical straight line of said transverse plane and, in projection in a longitudinal plane, is inclined toward the rear by an angle comprised between 5 and 45° with respect to a vertical straight line of said longitudinal plane.

According to one embodiment, the vent has a structure configured to allow a liquid to flow out of said vent.

According to one embodiment, the vent comprises a bent-over terminal portion with a convexity facing toward the ground, said bent-over terminal portion having an opening to allow liquid to flow out.

According to another embodiment, the vent comprises a terminal portion that has an orientation including a vertical component and a lower end equipped with an opening so as to allow the liquid to flow out, an upstream portion opening into said terminal portion transversely thereto.

According to yet another embodiment, the vent comprises a terminal portion which is inclined and which has a diameter greater than that of an upstream portion so that a space is left between a lower surface of the terminal portion and a lower surface of the upstream portion, so as to allow liquid to flow out.

According to one embodiment, the casing has an upper wall which is sloped, the slope being zero or preferably increasing from the front toward the rear, in the longitudinal direction of the handling equipment. This prevents pockets of gas from being created inside the casing.

According to one embodiment, the tank has a discharge valve for emptying the hydrogen from the tank, the discharge valve preferably being connected to a discharge circuit designed to convey the hydrogen from the tank toward the vent.

According to one embodiment, the fuel cell has a discharge valve for emptying the hydrogen from the fuel cell, the discharge valve preferably being connected to a discharge circuit designed to convey the hydrogen from the fuel cell toward the vent.

According to one embodiment, the handling equipment comprises at least two motors these being configured to actuate the load-handling device and to move the handling equipment, respectively.

According to one embodiment, the handling equipment comprises two electric motors which are coupled to the front axle and to the rear axle, respectively, via a transmission device.

According to one embodiment, the handling equipment comprises one electric motor which is coupled to the front axle and to the rear axle via a transmission device.

According to one embodiment, the motor for actuating the load-handling device is a motor that drives a hydraulic pump, the hydraulic pump being connected to one or more hydraulic rams designed to move a lifting arm of the load-handling device.

According to one embodiment, the load-handling device comprises a lifting arm which extends in a longitudinal plane between the casing and the driver's cab and which is mounted in an articulated manner on the chassis about a transverse axis of pivoting P.

According to one embodiment, the lifting arm is mounted articulated to the two longitudinal members, between these, so as to be mobile in pivoting with respect to the two longitudinal members about a transverse axis of pivoting P.

According to one embodiment, the lifting arm is a telescopic arm.

According to one embodiment, the handling equipment is a telescopic handler.

### BRIEF DESCRIPTION OF THE FIGURES

The invention will be better understood, and further objects, details, features and advantages thereof will become more clearly apparent, through the following description of a number of particular embodiments of the invention, these being given solely by way of nonlimiting illustration, and with reference to the attached drawings.

FIG. 1 is a schematic view from above of handling equipment according to a first embodiment.

FIG. 2 is a schematic view from the side of the handling equipment of FIG. 1.

FIG. 3 is a schematic view from above of handling equipment according to a second embodiment.

FIG. 4 is a schematic view from above of handling equipment according to a third embodiment.

FIG. 5 is a schematic view from above of handling equipment according to a fourth embodiment.

FIG. 6 is a schematic view in section of a vent intended to remove from the casing any hydrogen leaks that might occur, according to a first embodiment variant.

FIG. 7 is a schematic view in section of a vent intended to remove from the casing any hydrogen leaks that might occur, according to a second embodiment variant.

FIG. 8 is a schematic view in section of a vent intended to remove from the casing any hydrogen leaks that might occur, according to a third embodiment variant.

### DESCRIPTION OF THE EMBODIMENTS

By convention, the “longitudinal” direction of the handling equipment 1 corresponds to the front-rear orientation of the vehicle. Furthermore, the terms “front” and “rear”, respectively denoted as F and R in the figures, are used to define the relative position of one element with respect to another in the longitudinal direction. The median longitudinal axis, denoted X in the figures, is an axis oriented in the longitudinal direction and passing through the middle of the front axle 4 and rear axle 5 of the handling equipment 1. The “transverse” direction is oriented perpendicular to the longitudinal direction.

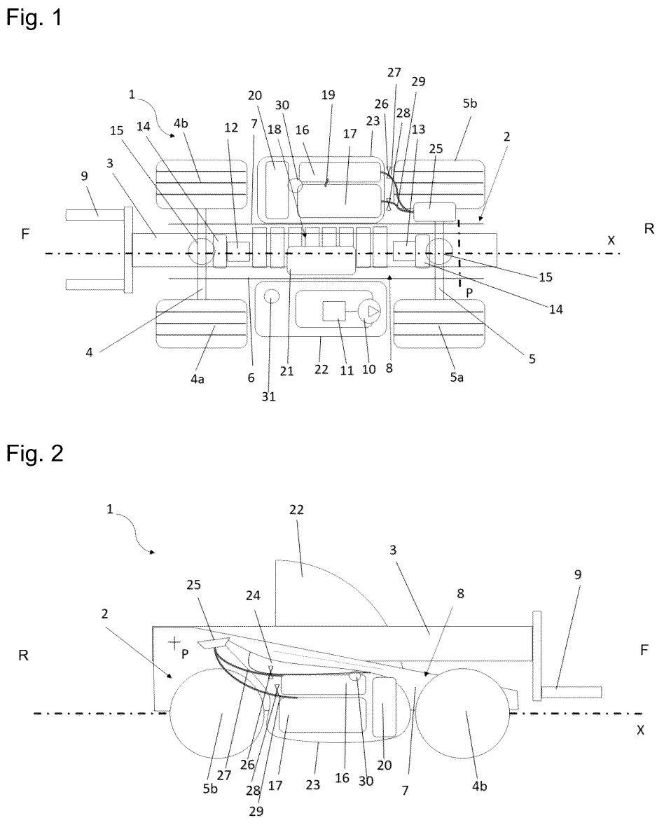

Handling equipment 1 according to a first embodiment is described with reference to FIGS. 1 and 2. The handling equipment 1 comprises a chassis 2 and a load-handling device, in this instance a lifting arm 3, which is mounted with the ability to move on the chassis 2. The lifting arm 3 is, for example, a telescopic arm. In this case, the handling equipment 1 may notably be a telescopic handler.

The chassis 2 is mobile. To achieve that, the handling equipment 1 comprises two axles: a front axle 4 and a rear axle 5, which are each mounted on the chassis 2 along the transverse axis and are each equipped with two wheels, one on the left 4a, 5a, and the other on the right 4b, 5b. Of the two axles that are the front axle 4 and the rear axle 5 at least one is mounted with the ability to rotate on the chassis 2.

In the embodiment depicted, the chassis 2 comprises a pair of longitudinal members 6, 7 visible in FIG. 1. The longitudinal members 6, 7 are generally flat, mutually parallel, metal components which extend parallel to the median longitudinal axis X respectively one on each side of said median longitudinal axis X. The longitudinal members 6, 7 are connected to one another in such a way as to form a space 8 able to house components of the handling equipment 1 which components will be detailed later on.

As depicted in FIG. 1, the lifting arm 3 extends in a longitudinal plane which is preferably a median plane, which is to say that the median longitudinal axis X is included in this plane. The lifting arm 3 is articulated to the two longitudinal members 6, 7, between these, so as to be mobile in pivoting with respect to the two longitudinal members 6, 7 about a transverse axis of pivoting P. The lifting arm 3 may be embodied in various ways, notably in the form of several telescopic sections or, as a variant, in the form of a fixed-length arm. One end of the lifting arm 3, which is the opposite end from the axis of pivoting P, may bear a working tool 9 or a modular tool-holder able to accept several types of working tools 9. What is meant by a working tool 9 is, for example, a pair of forks, a bucket, a winch, a gripper, etc.

The handling equipment 1 comprises one or more linear actuators, not depicted, such as hydraulic rams, which are each mounted articulated, on the one hand, to the lifting arm 3 and, on the other hand, to the chassis 2 of the handling equipment 1, thus allowing the lifting arm 3 to be pivoted with respect to the chassis 2 of the handling equipment 1 about the axis of pivoting P. The hydraulic rams are connected to a hydraulic circuit equipped with a hydraulic pump 10, visible in FIG. 1. In the embodiment depicted, the hydraulic pump 10 is driven by a motor, such as an electric motor 11.

Moreover, the handling equipment 1 comprises at least one electric motor 12, 13 which is configured to cause the handling equipment 1 to move. In the embodiment depicted in FIG. 1, the handling equipment 1 comprises two electric motors 12, 13 causing it to move. Each electric motor 12, 13 is coupled to one of the front axle 4 or rear axle 5 via a transmission device. Thus, the handling equipment 1 has four-wheel drive. In the embodiment depicted, each transmission device comprises a reduction gear 14 and a differential 15. Alternatively, the transmission device is a hydraulic transmission device.

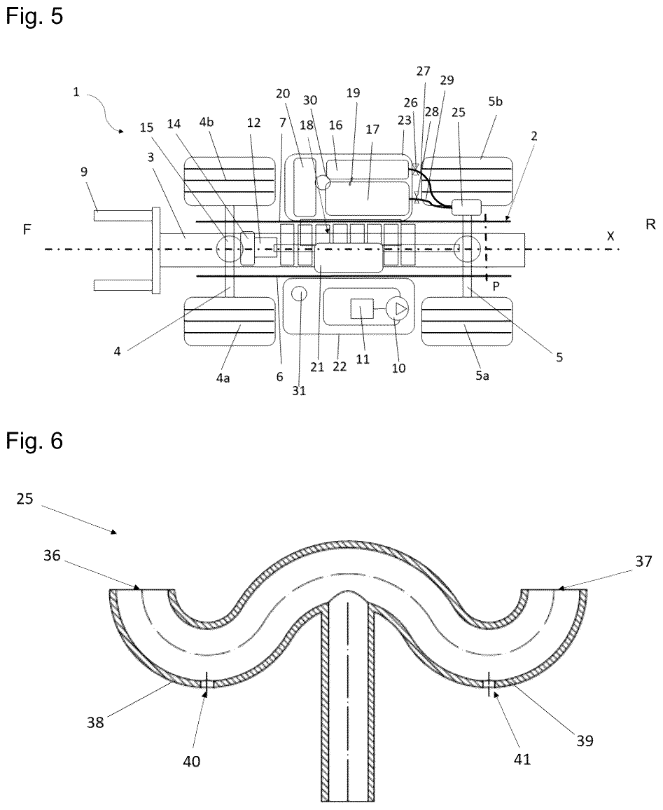

According to an alternative embodiment depicted in FIG. 5, the handling equipment 1 comprises just one electric motor 12 to cause the handling equipment 1 to move. In such instances, the transmission device is designed to couple said electric motor 12 to both the front axle 4 and the rear axle 5. The handling equipment 1 then likewise has four-wheel drive. According to another embodiment which has not been depicted, the electric motor 12 is coupled to just one of the two axles 4, 5 so that the handling equipment 1 has just two-wheel drive.

The handling equipment 1 moreover comprises a power supply system to supply electrical energy to at least one and preferably all of the aforementioned electric motors 11, 12, 13. The electrical power supply system comprises a tank 16 intended to store hydrogen, a fuel cell 17 and an electrical energy storage device comprising one or more batteries 18 and/or one or more supercapacitors. The terminals of the batteries 18 and/or of the supercapacitors are connected to the electric motor(s) 11, 12, 13 in parallel with the fuel cell 17.

The tank 16 is, for example, suitable for storing hydrogen in the gaseous state at a maximum pressure of between 300 and 700 bar, for example of the order of 350 bar. According to another embodiment, the tank 16 is suitable for storing hydrogen in the solid state in the form of metal hydrides.

The tank 16 is connected to the fuel cell 17 by a circuit 19 which is notably equipped with an expansion valve, not illustrated, enabling the hydrogen pressure to be lowered. The fuel cell 17 is, further, equipped with an air supply compressor able to compress the oxidant air at the inlet to the cells of the fuel cell 17. The fuel cell may also comprise a humidifier device able to humidify the hydrogen and the air at the inlet to the fuel cell 17.

As is known per se, the fuel cell 17 is where an oxidation-reduction reaction takes place that converts the hydrogen from the tank 16, and the oxygen from the air supplied by the compressor, into electricity, water and heat.

Hence, the handling equipment 1 also comprises a cooling device 20 able to cool the fuel cell 17, as well as a water-collection device, not depicted, able to collect the water discharged by the fuel cell 17. According to one embodiment, the coupling device 20 comprises a cooling circuit equipped with a heat exchanger. Furthermore, the water-collection device may be connected to a water discharge orifice for removing the water, or to a tank for storing the water. The water-collection device may be associated with the cooling device 20 such that the water collected is used for cooling the fuel cell 17. The water-collection device may also be connected to the humidifier device in order to supply same with water.

The handling equipment 1 further comprises power electronics which notably include a DC/DC voltage converter 21 which is connected, on the one hand, to the fuel cell 17 and, on the other hand, to the electric motors 11, 12, 13 and to the electrical energy storage device, in this instance the batteries 18. The DC/DC voltage converter 21 is able to convert the level of voltage delivered by the fuel cell 17 to the level of voltage required by the electric motors 11, 12, 13 and the batteries 18.

The handling equipment 1 also comprises control means, not illustrated, which are configured to control the fuel cell 17, the electric motors 11, 12, 13 and the DC/DC voltage converter 21 on the basis of command signals delivered by the controls of the handling equipment 1, such as a throttle pedal and/or a joystick in particular.

Moreover, the handling equipment 1 comprises a driver's cab 22 in which a driver may be accommodated and which is notably equipped with a seat, not depicted, and with controls for operating the handling equipment 1. The driver's cab 22 is positioned on a first side of the median longitudinal axis X and between the front axle 4 and the rear axle 5.

The handling equipment 1 further comprises a casing 23 which is positioned, with respect to the driver's cab 22, on the other side of the median longitudinal axis X of the handling equipment 1. More particularly, the casing 23 and the driver's cab 22 are positioned one on each side of the pair of longitudinal members 6, 7 and of the lifting arm 3.

In the first embodiment depicted in FIGS. 1 and 2, the tank 16, the fuel cell 17, the circuit 19 connecting the tank 16 to the fuel cell 17, and the cooling device 20 are all housed inside the casing 23.

As illustrated in FIG. 2, the casing 23 is equipped with a lid 24 which is mobile and thus allows access to the equipment housed inside said casing 23, notably for the purposes of maintenance operations. The lid 24 forms an upper part of the casing 23. The lid 24 is, for example, mounted for pivoting along its edge closest to the median longitudinal axis X about an axis of pivoting that is generally parallel to the longitudinal direction.

The casing 23 comprises an air inlet opening, not depicted, which is advantageously formed at the front of the casing 23 and allows the compressor of the fuel cell 17 to be supplied with air. The casing 23 also comprises a vent 25 which allows any hydrogen leaks and oxidant air leaving the fuel cell 17 to be removed from the casing 23. As depicted in FIGS. 1 and 2, the vent 25 is positioned in a rear portion of the casing 23. Advantageously, the rear portion of the casing 23 in which portion the vent 25 is formed is the uppermost portion of the casing 23. Furthermore, the slope of the upper wall of the casing 23 is a slope which, in the longitudinal direction of the handling equipment, from the front toward the rear, is zero or preferably increasing. In other words, for any pair of points belonging to the internal surface of the upper wall of the casing 23 which are aligned in the longitudinal direction of the handling equipment 1, the slope, considered from front to rear, is zero or increasing.

Advantageously, as illustrated in FIG. 2, the vent 25 is positioned, relative to the driver's cab 22, further toward the rear of the handling equipment 1. In particular, the vent 25 is advantageously positioned above that wheel 5b of the rear axle 5 that is on the same side as the casing 23, namely above the right-hand rear wheel 5b in the embodiment depicted.

Advantageously, the vent 25 is oriented such that the direction of the flow of gas leaving the vent 25 is inclined upward, and preferably toward the rear and toward the outside of the handling equipment 1. More particularly, the vent 25 is directed upward and is inclined in such a way that the direction of the gas flow, in projection in a transverse plane, is inclined toward the outside by an angle comprised between 5 and 45° with respect to a vertical straight line of said transverse plane and, in projection in a longitudinal plane, is inclined toward the rear by an angle comprised between 5 and 45° with respect to a vertical straight line of said longitudinal plane.

In addition, the vent 25 is advantageously positioned close to the pair of longitudinal members 6, 7. More particularly, the vent 25 is positioned, closer in a transverse direction, to the median longitudinal axis X than to a lateral end of the handling equipment 1 on the same side as the casing 23. In addition, the vent 25 is positioned at a height that is below that of the upper edge of the rear end of the lifting arm 3. This prevents the vent 25 from being obstructed in the event of the handling equipment 1 overturning.

FIG. 6 illustrates the structure of a vent 25 according to a first embodiment variant. Because the direction of the flow of gas leaving the vent 25 is inclined upward, the structure of the vent 25 is advantageously configured to allow liquid to flow out of the vent 25 and thus prevent a liquid, such as rainwater for example, from opposing the removal of any hydrogen leaks that might occur, notably when the liquid turns to ice under the effect of negative temperatures.

In this embodiment, the vent 25 comprises two outlet orifices 36, 37. However, according to another embodiment variant which has not been depicted, the vent 25 may comprise just one outlet orifice. The vent 25 comprises, upstream of each outlet orifice 36, 37, a bent-over terminal portion 38, 39 with a convexity facing downward and which has an opening 40, 41 positioned near the lowermost point of said bent-over terminal portion 38, 39, so as to allow liquid to flow out.

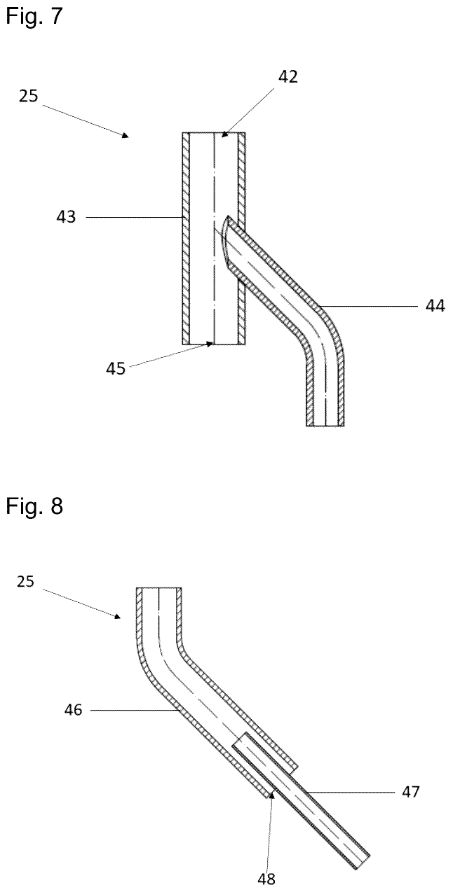

FIG. 7 illustrates a vent 25 according to another embodiment variant. The outlet orifice 42 here is formed at the end of a terminal portion 43 that has an orientation including a vertical component, is connected to an upstream portion 44 which opens transversely into said terminal portion 43 and which has a lower end having an opening 45 so as to allow liquid to flow out.

FIG. 8 illustrates a vent 25 according to yet another embodiment variant. In this embodiment, the terminal portion 46 is inclined and has a diameter greater than that of the upstream portion 47. Thus, a space 48 is left between the lower surface of the terminal portion 46 and the lower surface of the upstream portion 47 so as to allow liquid to flow out.

Moreover, according to one advantageous embodiment, the casing 23 is equipped with a fan, not illustrated, that allows the air inside the casing 23 to be renewed more rapidly, notably in the event of a hydrogen leak.

Furthermore, the tank 16 comprises a discharge valve 26 to allow the tank 16 to be emptied of its contents. The discharge valve 26 is connected to a discharge circuit 27 which conveys the hydrogen from the tank 16 to the vent 25. Moreover, in the embodiment depicted, the fuel cell 17 also comprises a discharge valve 28 which is connected to a discharge circuit 29 which also allows the hydrogen contained in the fuel cell 17 to be emptied and conveyed to the vent 25.

The handling equipment 1 comprises at least one hydrogen detector 30 housed in the casing 23. The hydrogen detector 30 is advantageously positioned in an upper portion of the casing 23, which is to say that it is positioned above the tank 16 and above the fuel cell 17. According to one advantageous embodiment, the handling equipment 1 comprises other hydrogen detectors distributed through other zones of the handling equipment 1 and notably a hydrogen detector 31 which is housed in the driver's cab 22.

The hydrogen detectors 31 are connected to a control unit, not depicted, which is configured to generate an audible or visible alarm signal in response to the detection of a quantity of hydrogen that is above a determined threshold quantity. In such an event, the control unit also performs one or more of the following actions: switching on the fan, shutting down the fuel cell 17, opening the discharge valve 27 of the tank 16 and opening the discharge valve 28 of the fuel cell 17.

Moreover, as illustrated in FIG. 1, the electrical energy storage device, which in this instance is made up of a set of batteries 18, is arranged inside the space 8 formed between the two longitudinal members 6, 7. The batteries 18 may, in principle, be of any known type, for example of the lead-acid type or preferably of the lithium-ion type.

In the embodiment depicted, the DC/DC voltage converter 21 is also housed in the space 8. This siting of the electrical energy storage device and of the DC/DC voltage converter 21 in the space 8 notably allows these to be separated from the tank 16 and from the fuel cell 17, making it possible to limit the risk of these components catching fire or overheating. According to another embodiment, the DC/DC voltage converter 21 is housed inside the casing 23.

Moreover, in the embodiment depicted, the hydraulic pump 10 and also the electric motor 11 are housed in a dedicated space formed beneath the driver's cab 22.

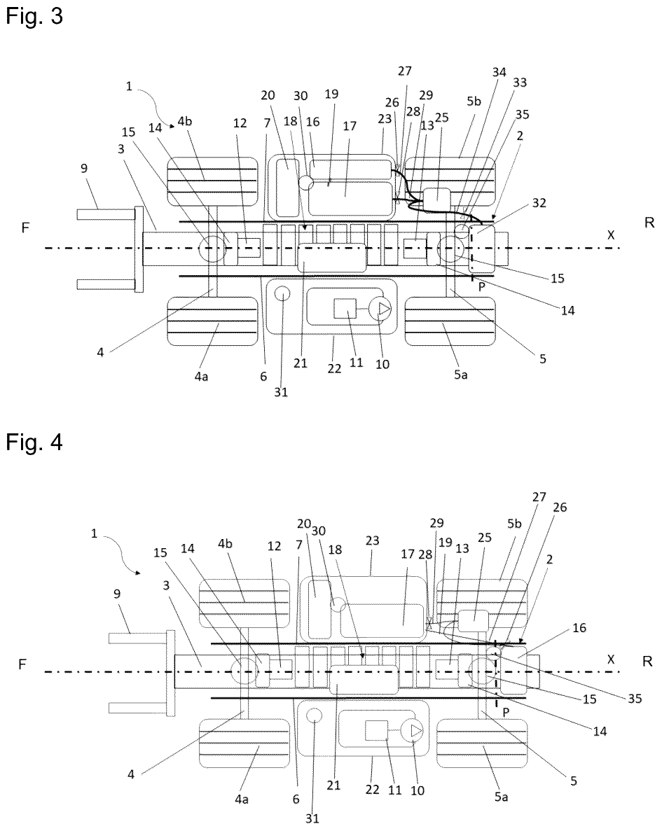

FIG. 3 depicts handling equipment 1 according to a second embodiment. This handling equipment 1 differs from that described hereinabove in connection with FIGS. 1 and 2 in that it comprises an additional tank 32 intended to store hydrogen. The additional tank 32 is not housed inside the casing 23 but positioned at the rear of the handling equipment 1. This embodiment is advantageous in that it offers greater hydrogen storage capacity. The additional tank 32 is positioned transversely here, between the two wheels 5a, 5b of the rear axle 5. In the embodiment depicted, the additional tank 32 likewise has a discharge valve 33 allowing it to be emptied. The discharge valve 33 is connected to a discharge circuit 34 which conveys the hydrogen to the vent 25. The handling equipment then comprises a hydrogen detector 35.

FIG. 4 depicts handling equipment 1 according to yet another embodiment. This embodiment differs from that described hereinabove in connection with FIGS. 1 and 2 in that the tank 16 is not housed inside the casing 23 but positioned at the rear of the handling equipment 1, like the additional tank 32 in FIG. 3.

Although the invention has been described in connection with a number of particular embodiments, it is quite obvious that it is not in any way restricted to these and that it can comprise any technical equivalents of the means described and combinations thereof where these fall within the scope of the invention as defined by the claims.

The use of the verbs “comprise”, “include” or “have” and the conjugated forms thereof does not exclude the presence of elements or steps other than those listed in a claim.

In the claims, any reference symbol between parentheses must not be interpreted as a limitation on the claim.

What is claimed is:

1. Handling equipment (1) comprising:
a chassis (2) having a median longitudinal axis (X);
a load-handling device (3) which is mounted such as to be able to move on the chassis (2);
an electric motor (11, 12, 13) which is configured to move the handling equipment (1) or to actuate the load-handling device (3);
a fuel cell (17) which is configured to generate electrical energy intended to power the electric motor (11, 12, 13);
a tank (16, 32) intended to contain hydrogen and connected to the fuel cell (17) in order to supply same with hydrogen;
a driver's cab (22) which is fixed to the chassis (2) and is positioned on a first side of the chassis (2) with respect to the median longitudinal axis (X) of the chassis (2);
a casing (23) which is fixed to the chassis (2) and is positioned on a second side of the chassis (2) which is the opposite to the first side, with respect to the median longitudinal axis (X) of the chassis (2);
of the fuel cell (17) and the tank (16, 32) at least one being housed inside said casing (23).

2. The handling equipment (1) as claimed in claim 1, wherein the chassis (2) comprises a pair of longitudinal members (6, 7) extending longitudinally one respectively on each side of said median longitudinal axis (X), the driver's cab (22) and the casing (23) being positioned one on each side of the pair of longitudinal members (6, 7).

3. The handling equipment (1) as claimed in claim 1 or 2, further comprising an electrical energy storage device (18), the fuel cell (1) and the electrical energy storage device (18) being electrically connected, on the one hand, to one another and, on the other hand, in parallel, to the electric motor (11, 12, 13).

4. The handling equipment (1) as claimed in claims 2 and 3 considered in combination, wherein the electrical energy storage device (18) is housed in a space (8) formed between the longitudinal members of the pair of longitudinal members (6, 7).

5. The handling equipment (1) as claimed in claim 3 or 4, further comprising a DC/DC voltage converter (21) which is connected, on the one hand, to the fuel cell (17) and, on the other hand, to the electric motor (11, 12, 13) and to the energy storage device (18).

6. The handling equipment (1) as claimed in any one of claims 1 to 5, wherein the fuel cell (17) and the tank (16) are housed inside the casing (23).

7. The handling equipment (1) as claimed in any one of claims 1 to 6, comprising a hydrogen detector (30) which is housed inside the casing (23).

8. The handling equipment (1) as claimed in any one of claims 1 to 7, wherein the casing (23) has a vent (25) for removing a flow of gas from an internal space of the casing (23).

9. The handling equipment (1) as claimed in claim 8, wherein the vent (25) is positioned closer, in a transverse direction, to the median longitudinal axis (X) than to a lateral end of the handling equipment (1) on the second side and below an upper edge of the load-handling device (3) in a lowered position.

10. The handling equipment (1) as claimed in claim 8 or 9, wherein the vent (25) is positioned in an upper rear portion of the casing (23).

11. The handling equipment (1) as claimed in any one of claims 8 to 10, comprising a front axle (4) and a rear axle (5) which are mounted on the chassis (2) transversely with respect to the median longitudinal axis (X) and which each comprise two wheels (4a, 4b, 5a, 5b), and wherein the vent (25) is positioned above that wheel (5b) of the rear axle (5) which is positioned on the second side.

12. The handling equipment (1) as claimed in any one of claims 8 to 11, wherein the vent (25) is directed upward.

13. The handling equipment (1) as claimed in claim 12, wherein the vent (25) is inclined in such a way that the direction of the gas flow, in projection in a transverse plane, is inclined toward the outside by an angle comprised between 5 and 45° with respect to a vertical straight line of said transverse plane and, in projection in a longitudinal plane, is inclined toward the rear by an angle comprised between 5 and 45° with respect to a vertical straight line of said longitudinal plane.

14. The handling equipment (1) as claimed in claim 12 or 13, wherein the vent (25) has a structure configured to allow a liquid to flow out of said vent (25).

15. The handling equipment (1) as claimed in any one of claims 1 to 14, wherein the casing (23) has an upper wall which is sloped, the slope being zero or increasing from the front toward the rear, in the longitudinal direction of the handling equipment (1).

16. The handling equipment (1) as claimed in any one of claims 1 to 15, wherein the tank (16) has a discharge valve (26) for emptying the hydrogen from the tank (16), the discharge valve (26) being connected to a discharge circuit (27) designed to convey the hydrogen from the tank (16) toward the vent (25).

17. The handling equipment (1) as claimed in any one of claims 1 to 16, wherein the fuel cell (17) has a discharge valve (28) for emptying the hydrogen from the fuel cell (17), the discharge valve (28) being connected to a discharge circuit (27) designed to convey the hydrogen from the fuel cell (17) toward the vent (25).

18. The handling equipment (1) as claimed in any one of claims 1 to 17, comprising at least two motors (11, 14) these being configured to actuate the load-handling device and to move the handling equipment (1), respectively.

19. The handling equipment (1) as claimed in any one of claims 1 to 18, wherein the load-handling device comprises a lifting arm (3) which extends in a longitudinal plane between the casing (23) and the driver's cab (22) and which is mounted in an articulated manner on the chassis (2) about a transverse axis of pivoting (P).
